(19) United States
(12) Patent Application Publication
(10) Pub. No.: US 2026/0316727 A1
(43) Pub. Date: Oct. 15, 2026

(54) BRAKING CONTROL DEVICE

(71) Applicant: ADVICS CO., LTD., Kariya-shi, Aichi-ken (JP)

(72) Inventor: Yusaku YAMAMOTO, Kariya-shi, Aichi-ken (JP)

(73) Assignee: ADVICS CO., LTD., Kariya-shi, Aichi-ken (JP)

(21) Appl. No.: 19/484,784

(22) PCT Filed: May 29, 2024
(86) PCT No.: PCT/JP2024/019755

§ 371 Date: Nov. 14, 2025

(30) Foreign Application Priority Data
May 29, 2023 (JP) 2023-087679

(51) Int. Cl. B60T 8/1755; B60T 8/171; B60T 8/28

(52) U.S. Cl. CPC B60T 8/17551; B60T 8/171; B60T 8/28; B60T 2220/04; B60T 2230/04; B60T 2250/00

(57) ABSTRACT

A braking control device is made to function as a stop-related value acquisition unit that acquires a stop-related value so that the value decreases as a vehicle approaches a predetermined stop position, a control unit that starts stop-time braking control for stopping the vehicle in a state in which the braking force applied to the vehicle is smaller than a requested braking force when the stop-related value is equal to or less than a threshold value, and a threshold value setting unit that sets the threshold value to a smaller value as the stop-related value decreases before the stop-time braking control is started.

### TECHNICAL FIELD

The present disclosure relates to a braking control device that controls a braking force applied to a vehicle when a braking request for the vehicle is generated.

### BACKGROUND ART

PTL 1 discloses a control device that executes braking control for suppressing a rapid change in a pitch attitude of a vehicle upon stopping. The control device controls the motor generator so that the regenerative braking force decreases toward 0 (zero) when the vehicle speed is equal to or less than a predetermined speed. Then, when the vehicle speed is 0 (zero), the control device operates the hydraulic actuator to increase the friction braking force.

### CITATION LIST

### Patent Literature

Patent Literature 1: JP 2016-28913 A

### SUMMARY

### Technical Problem

During traffic congestion, the vehicle may repeatedly travel at a low speed and stop due to vehicle braking.

When a braking force is applied to a vehicle traveling at a low speed, the vehicle immediately stops. That is, the vehicle may stop before the above-described braking control is started. In such a case, it is not possible to suppress a rapid change in the pitch attitude of the vehicle upon stopping.

### Solution to Problems

A braking control device for solving the above problem includes a stop-related value acquisition unit that acquires a stop-related value whose value decreases as a vehicle approaches a predetermined stop position, a control unit that starts stop-time braking control for stopping the vehicle in a state in which a braking force applied to the vehicle is smaller than a requested braking force that is a requested value of a braking force applied to the vehicle when the stop-related value is equal to or less than a predetermined threshold value, and a threshold value setting unit that sets the threshold value to a smaller value as the stop-related value is smaller before the stop-time braking control is started.

### Advantageous Effects

The braking control device has the effect of being able to suppress a rapid change in the pitch attitude of the vehicle upon stopping even when a braking request is generated in the vehicle traveling at a low speed.

### BRIEF DESCRIPTION OF DRAWINGS

FIG. 1 is a configuration diagram schematically illustrating a vehicle including a braking control device according to an embodiment.

FIG. 2(A), FIG. 2(B), FIG. 2(C) and FIG. 2(D) are timing charts when stop-time braking control is executed.

FIG. 3 is a map illustrating a relationship between a basic value of a first vehicle body speed determination value and a vehicle body speed.

FIG. 4 is a flowchart illustrating a series of processes executed by the braking control device in FIG. 1.

FIG. 5(A), FIG. 5(B), FIG. 5(C) and FIG. 5(D) are timing charts when stop-time braking control is executed in the braking control device in FIG. 1.

FIG. 6(A), FIG. 6(B), FIG. 6(C) and FIG. 6(D) are timing charts when the stop-time braking control is executed in the braking control device of the modification.

### DESCRIPTION OF EMBODIMENT

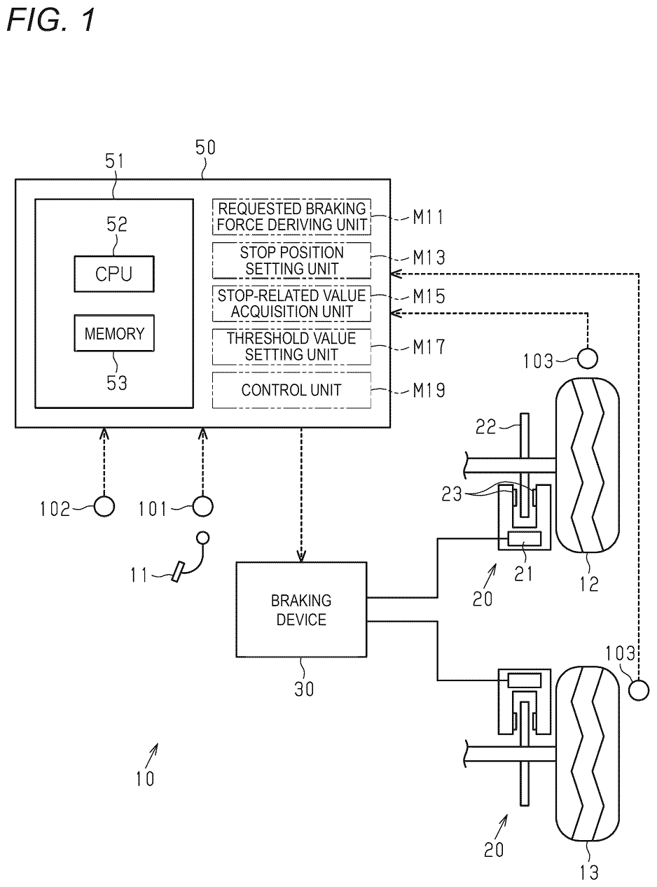

Hereinafter, an embodiment of a braking control device will be described with reference to FIGS. 1 to 5.

FIG. 1 illustrates a vehicle 10 including a braking control device 50. The vehicle 10 includes a braking operation member 11, a plurality of wheels, a plurality of friction brakes 20, and a braking device 30. The braking operation member 11 is a member operated by the driver when applying a braking force to the vehicle 10. An example of the braking operation member 11 is a brake pedal. The plurality of wheels includes two front wheels 12 and two rear wheels 13.

### <Friction Brake>

The plurality of friction brakes 20 applies the braking force to the corresponding wheels. The friction brake 20 includes a wheel cylinder 21, a rotating body 22, and a friction portion 23. Since the rotating body 22 rotates integrally with the wheel, a braking force is applied to the wheel by pressing the friction portion 23 against the rotating body 22. The force pressing the friction portion 23 against the rotating body 22 increases as the wheel hydraulic pressure, which is the hydraulic pressure in the wheel cylinder 21, increases. Therefore, the friction brake 20 can apply a larger braking force to the wheel as the wheel hydraulic pressure is higher.

### <Braking Device>

The braking device 30 controls the braking force applied to the wheels 12 and 13 by controlling the wheel hydraulic pressure of the plurality of wheel cylinders 21. For example, the braking device 30 includes a pressurizing source that supplies the brake fluid to the plurality of wheel cylinders 21. The pressurizing source is, for example, an electric pump and an electric cylinder. The braking device 30 can individually adjust the wheel hydraulic pressure of the wheel cylinder 21 for the front wheel 12 and the wheel hydraulic pressure of the wheel cylinder 21 for the rear wheel 13.

In the following description, the sum of the braking forces applied to the plurality of wheels 12 and 13 is referred to as “braking force BPAl applied to the vehicle 10”.

### <Detection System>

The braking control device 50 receives a detection signal from a detection system. The detection system includes a plurality of sensors. The plurality of sensors includes a brake sensor 101, a longitudinal acceleration sensor 102, and a plurality of wheel speed sensors 103.

The brake sensor 101 detects information related to the operation of the braking operation member 11 by the driver. An example of the brake sensor 101 is a stroke sensor that detects an operation amount of the braking operation member 11 by the driver. An operation amount based on the detection signal of the brake sensor 101 is referred to as an “operation amount X”. Note that the detection system may include a sensor that detects the operation force of the braking operation member 11 by the driver.

The longitudinal acceleration sensor 102 detects acceleration in the longitudinal direction of the vehicle 10 among accelerations acting on the vehicle 10. The acceleration in the longitudinal direction of the vehicle 10 based on the detection signal of the longitudinal acceleration sensor 102 is referred to as “longitudinal acceleration Gx”.

The wheel speed sensor 103 is provided for each of the plurality of wheels. The plurality of wheel speed sensors 103 detects the rotation speeds of the corresponding wheels. The rotation speed of the wheel based on the detection signal of the wheel speed sensor 103 is referred to as a “wheel speed VW”.

### <Braking Control Device>

The braking control device 50 includes a processing circuit 51. An example of the processing circuit 51 is an electronic control device. In this case, the processing circuit 51 includes a CPU 52 and a memory 53. The memory 53 stores a control program executed by the CPU 52. When the CPU 52 executes the control program, the processing circuit 51 causes the braking device 30 to operate the plurality of friction brakes 20. That is, the processing circuit 51 can adjust the braking force BPAI applied to the vehicle 10 by operating the plurality of friction brakes 20.

### <Outline of Stop-Time Braking Control>

The processing circuit 51 executes the stop-time braking control when the driver operates the braking operation member 11. The stop-time braking control is braking control for stopping the vehicle 10 in a state where the braking force BPAl applied to the vehicle 10 is smaller than a requested braking force BPRq. The requested braking force BPRq is a requested value of the braking force BPA applied to the vehicle 10.

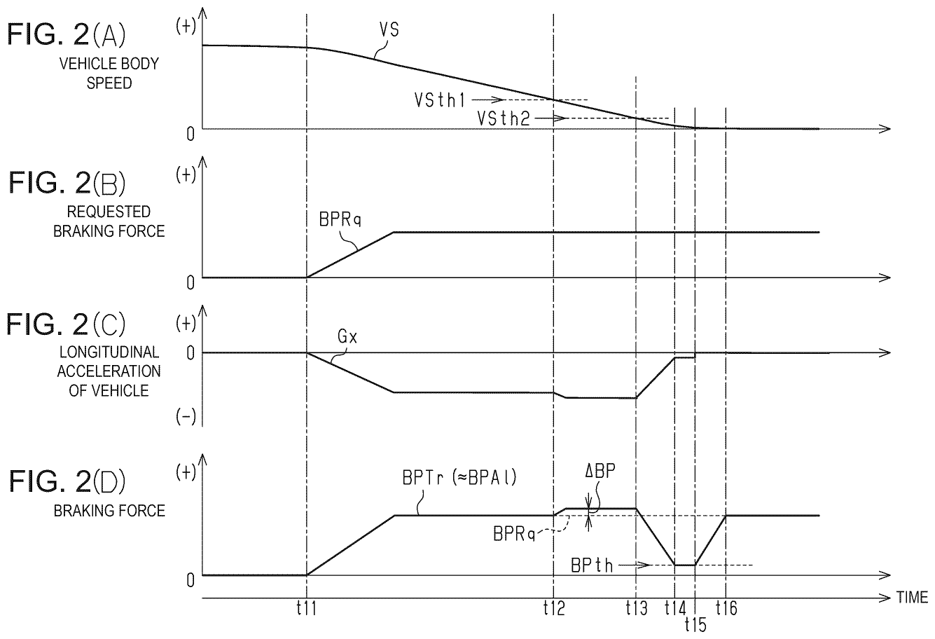

The stop-time braking control will be described with reference to FIGS. 2(A)-(2D).

The driver starts operating the braking operation member 11 at timing t11 under a situation where the vehicle 10 is traveling. In this case, as illustrated in FIG. 2(B), the processing circuit 51 derives the requested braking force BPRq. For example, the processing circuit 51 derives the requested braking force BPRq so that the larger the operation amount X of the braking operation member 11, the larger the value. When a vehicle body speed VS of the vehicle 10 is larger than a first vehicle body speed determination value VSth1 as before timing t12, the processing circuit 51 sets the requested braking force BPRq as an instruction braking force BPTr as illustrated in FIG. 2(D). Then, the processing circuit 51 controls the braking device 30 so that the braking force BPAl applied to the vehicle 10 is the instruction braking force BPTr. The vehicle body speed VS is a moving speed of the vehicle 10 derived based on the wheel speed VW.

When the braking force BPAl is applied to the vehicle 10 in this manner, the vehicle body speed VS decreases as illustrated in FIG. 2(A). As illustrated in FIG. 2(C), the absolute value of a longitudinal acceleration Gx increases as the braking force BPAl increases.

When the vehicle body speed VS reaches the first vehicle body speed determination value VSth1 at timing t12, the processing circuit 51 starts the stop-time braking control. The first vehicle body speed determination value VSth1 is a threshold value for setting the start timing of the stop-time braking control. From timing t12, the processing circuit 51 starts the increase correction process of the stop-time braking control. In the increase correction process, the processing circuit 51 sets the braking force larger than the requested braking force BPRq as the instruction braking force BPTr. For example, the processing circuit 51 sets the sum of the requested braking force BPRq and an offset value ΔBP as the instruction braking force BPTr. Then, the processing circuit 51 controls the braking device 30 so that the braking force BPAl applied to the vehicle 10 is the instruction braking force BPTr. As a result, even when the requested braking force BPRq is the same, the absolute value of the longitudinal acceleration Gx of the vehicle 10 is larger than that before timing t12 by the offset value ΔBP.

At timing t13, the vehicle body speed VS is a second vehicle body speed determination value VSth2. A vehicle body speed smaller than the first vehicle body speed determination value VSth1 is set as the second vehicle body speed determination value VSth2. When the vehicle body speed VS is equal to or less than the second vehicle body speed determination value VSth2, it can be regarded that the vehicle 10 has approached a stop position PS. The stop position PS is a predicted position at which the vehicle 10 stops. The processing circuit 51 shifts the process of the stop-time braking control from the increase correction process to the decrease correction process. In the decrease correction process, the processing circuit 51 reduces the instruction braking force BPTr at a constant speed. Then, the processing circuit 51 controls the braking device 30 so that the braking force BPAl applied to the vehicle 10 is the instruction braking force BPTr. As the processing circuit 51 executes the decrease correction process in this manner, the braking force BPAl is smaller than the requested braking force BPRq. As a result, even when the requested braking force BPRq is the same, the absolute value of the longitudinal acceleration Gx of the vehicle 10 gradually decreases.

At timing t14, the instruction braking force BPTr is equal to a stop holding braking force BPth. As the stop holding braking force BPth, a minimum braking force necessary for maintaining the stop of the vehicle 10 on the current traveling road surface of the vehicle 10 or a braking force slightly larger than the braking force is set. At timing t14, in the decrease correction process, the processing circuit 51 holds the instruction braking force BPTr by the stop holding braking force BPth.

At timing t15, since it is determined that the vehicle 10 has stopped, the processing circuit 51 shifts the process of the stop-time braking control from the decrease correction process to the degeneration process. In the degeneration process, the processing circuit 51 increases the instruction braking force BPTr. For example, the processing circuit 51 increases the instruction braking force BPTr to the requested braking force BPRq. The processing circuit 51 controls the braking device 30 based on the instruction braking force BPTr, so that the braking force BPAl applied to the vehicle 10 increases. When the instruction braking force BPTr is equal to the requested braking force BPRq at timing t16, the processing circuit 51 ends the stop-time braking control.

### <Function Unit>

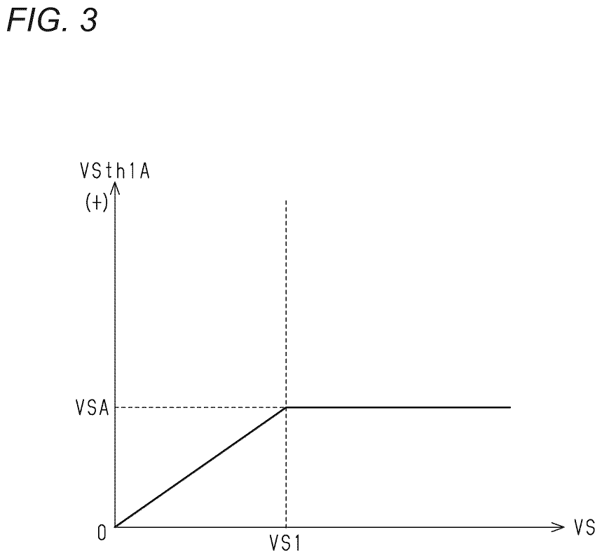

A functional configuration of the braking control device 50 will be described with reference to FIGS. 1 and 3.

As illustrated in FIG. 1, the processing circuit 51 functions as a requested braking force deriving unit M11, a stop position setting unit M13, a stop-related value acquisition unit M15, a threshold value setting unit M17, and a control unit M19 by the CPU 52 executing a control program of the memory 53.

The requested braking force deriving unit M11 derives the requested braking force BPRq so that the value increases as the operation amount X of the braking operation member 11 increases.

The stop position setting unit M13 sets a target position at which the vehicle 10 is stopped as the stop position PS when the vehicle 10 is decelerated by the application of the braking force. For example, the stop position setting unit M13 derives the stop position PS based on the vehicle body speed VS of the vehicle 10 and a deceleration DVS of the vehicle 10. The deceleration DVS is a deceleration correlated with the braking force BPAl applied to the vehicle 10. For example, the deceleration DVS can be derived by time-differentiating the vehicle body speed VS and inverting the positive/negative of the calculated value. Therefore, when the vehicle 10 is decelerating, the deceleration DVS has a positive value.

Then, the stop position setting unit M13 derives the stop position, of the vehicle 10, that can be predicted from the vehicle body speed VS and the deceleration DVS as the stop position PS. Specifically, the stop position setting unit M13 sets, as the stop position PS, a position closer to the current position of the vehicle 10 as the vehicle body speed VS is smaller. In addition, the stop position setting unit M13 sets, as the stop position PS, a position closer to the current position of the vehicle 10 as the deceleration DVS is larger.

A stop-related value acquisition unit M15 acquires a stop-related value whose value decreases as the vehicle 10 approaches the stop position PS. For example, the stop-related value acquisition unit M15 acquires the stop-related value at the time of deceleration of the vehicle 10 by application of the braking force. In the present embodiment, the stop-related value acquisition unit M15 acquires the vehicle body speed VS of the vehicle 10 as the stop-related value. It can also be said that the stop-related value is a parameter in which the value gradually decreases with the lapse of time when the vehicle 10 is decelerated by the application of the braking force BPAl.

The threshold value setting unit M17 sets the first vehicle body speed determination value VSth1 which is a threshold value for determining the start timing of the stop-time braking control. Before the start of the stop-time braking control, the threshold value setting unit M17 sets the first vehicle body speed determination value VSth1 to a smaller value as the vehicle body speed VS acquired by the stop-related value acquisition unit M15 is smaller. At this time, the threshold value setting unit M17 sets, as the first vehicle body speed determination value VSth1, a vehicle body speed smaller than the vehicle body speed VS at the time of setting the first vehicle body speed determination value VSth1.

In the present embodiment, the threshold value setting unit M17 sets the second vehicle body speed determination value VSth2 at the timing of setting the first vehicle body speed determination value VSth1. Specifically, the threshold value setting unit M17 sets the second vehicle body speed determination value VSth2 to a smaller value as the vehicle body speed VS acquired by the stop-related value acquisition unit M15 is smaller.

The threshold value setting unit M17 sets the first vehicle body speed determination value VSth1 and the second vehicle body speed determination value VSth2 when a braking request for the vehicle 10 is generated. That is, the threshold value setting unit M17 sets the first vehicle body speed determination value VSth1 to a smaller value as the vehicle body speed VS at the time when the braking request is generated is smaller. Similarly, the threshold value setting unit M17 sets the second vehicle body speed determination value VSth2 to a smaller value as the vehicle body speed VS at the time when the braking request is generated is smaller.

The threshold value setting unit M17 sets the first vehicle body speed determination value VSth1 and the second vehicle body speed determination value VSth2 based on the deceleration DVS of the vehicle 10 in addition to the vehicle body speed VS. For example, the threshold value setting unit M17 sets the first vehicle body speed determination value VSth1 so that the larger the deceleration DVS at the time when the braking request is generated, the smaller the value. Similarly, the threshold value setting unit M17 sets the second vehicle body speed determination value VSth2 so that the larger the deceleration DVS at the time when the braking request is generated, the smaller the value.

Here, an example of setting of the first vehicle body speed determination value VSth1 will be described with reference to FIG. 3. FIG. 3 is a map illustrating a relationship between the basic value VSth1A of the first vehicle body speed determination value VSth1 and the vehicle body speed VS. As illustrated in FIG. 3, when the vehicle body speed VS is greater than or equal to the first vehicle body speed VS1, the threshold value setting unit M17 sets the reference vehicle body speed VSA as the basic value VSth1A. For example, a criterion for determining whether the vehicle 10 is traveling at a low speed is set as the first vehicle body speed VS1. On the other hand, when the vehicle body speed VS is smaller than a first vehicle body speed VS1, the threshold value setting unit M17 sets, as the basic value VSth1A, a value that is smaller as the vehicle body speed VS is smaller.

In addition, the threshold value setting unit M17 sets a decrease correction gain Gd based on the deceleration DVS of the vehicle 10. At this time, the threshold value setting unit M17 sets a value larger than 0 (zero) and equal to or smaller than 1 as the decrease correction gain Gd. For example, the threshold value setting unit M17 sets, as the decrease correction gain Gd, a value that is smaller as the deceleration DVS increases.

Then, the threshold value setting unit M17 sets a product of the basic value VSth1A of the first vehicle body speed determination value and the decrease correction gain Gd as the first vehicle body speed determination value VSth1. Accordingly, the threshold value setting unit M17 can set the first vehicle body speed determination value VSth1 based on the vehicle body speed VS and the deceleration DVS.

The threshold value setting unit M17 can set the second vehicle body speed determination value VSth2 by a method similar to the method of setting the first vehicle body speed determination value VSth1.

The control unit M19 controls the operation of the braking device 30. Specifically, the control unit M19 Starts the stop-time braking control when the vehicle body speed VS is equal to or less than the first vehicle body speed determination value VSth1 during vehicle braking.

### <Flow of Processing at the Time of Vehicle Braking>

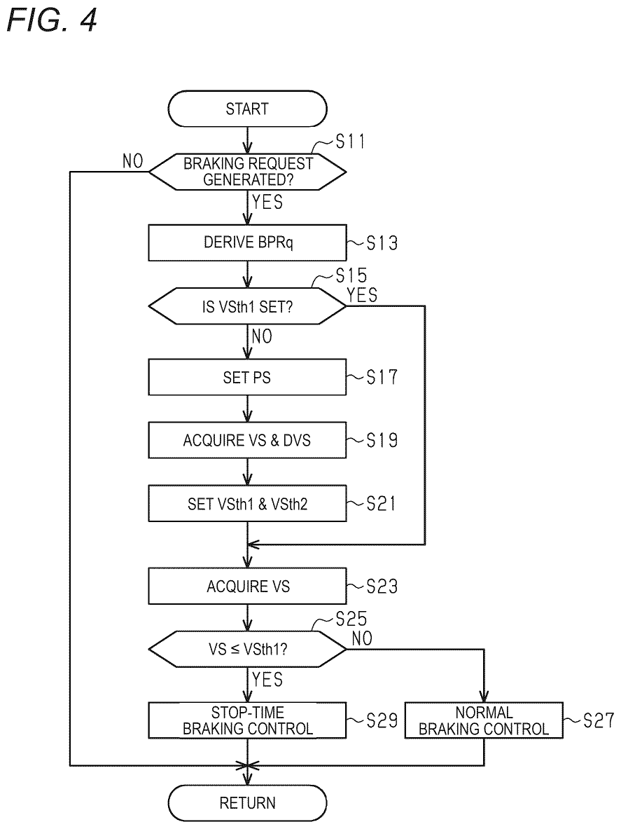

With reference to FIG. 4, a series of processes when the processing circuit 51 executes the stop-time braking control will be described. The processing circuit 51 repeatedly executes a series of processes illustrated in FIG. 4.

In step S11, the processing circuit 51 determines whether a braking request for the vehicle 10 is generated. For example, when detecting that the driver operates the braking operation member 11, the processing circuit 51 determines that the braking request is generated. The processing circuit 51 can detect that the driver is operating the braking operation member 11 based on the detection signal of the brake sensor 101. When determining that the braking request is generated (S11: YES), the processing circuit 51 shifts the process to step S13. On the other hand, when determining that the braking request is not generated (S11: NO), the processing circuit 51 temporarily ends the series of processes.

In step S13, the processing circuit 51 derives the requested braking force BPRq by functioning as the requested braking force deriving unit M11. In subsequent step S15, the processing circuit 51 determines whether the first vehicle body speed determination value VSth1 has been set during the current vehicle braking. When determining that the first vehicle body speed determination value VSth1 has been set (S15: YES), the processing circuit 51 shifts the process to step S23. On the other hand, when determining that the first vehicle body speed determination value VSth1 has not been set (S15: NO), the processing circuit 51 shifts the process to step S17.

In step S17, the processing circuit 51 functions as the stop position setting unit M13 to set the stop position PS. At this time, the processing circuit 51 sets the stop position PS based on the vehicle body speed VS and the deceleration DVS at the time of generation of the current braking request.

In subsequent step S19, the processing circuit 51 functions as the stop-related value acquisition unit M15 to acquire the current vehicle body speed VS. In addition, the processing circuit 51 acquires the current deceleration DVS of the vehicle 10.

In the next step S21, the processing circuit 51 functions as a threshold value setting unit M17 to set the first vehicle body speed determination value VSth1 and the second vehicle body speed determination value VSth2. At this time, the processing circuit 51 sets the first vehicle body speed determination value VSth1 and the second vehicle body speed determination value VSth2 based on the vehicle body speed VS and the deceleration DVS acquired in step S19. Then, the processing circuit 51 shifts the process to step S23.

In step S23, the processing circuit 51 functions as the stop-related value acquisition unit M15 to acquire the vehicle body speed VS at that time.

Then, in step S25, the processing circuit 51 determines whether the vehicle body speed VS acquired in step S23 is equal to or less than the first vehicle body speed determination value VSth1. When the vehicle body speed VS is equal to or less than the first vehicle body speed determination value VSth1 (S25: YES), the processing circuit 51 shifts the process to step S29. On the other hand, when the vehicle body speed VS is larger than the first vehicle body speed determination value VSth1 (S25: NO), the processing circuit 51 shifts the process to step S27.

In step S27, the processing circuit 51 functions as the control unit M19 to execute the normal braking control. In the normal braking control, the processing circuit 51 sets the requested braking force BPRq derived in step S13 as the instruction braking force BPTr. Then, the processing circuit 51 controls the braking device 30 so that the braking force BPAl is the instruction braking force BPTr. Thereafter, the processing circuit 51 temporarily ends the series of processes.

In step S29, the processing circuit 51 functions as the control unit M19 to execute the stop-time braking control. In the stop-time braking control, the processing circuit 51 executes the increase correction process in a case where the vehicle body speed VS is larger than the second vehicle body speed determination value VSth2. That is, the processing circuit 51 sets the braking force larger than the requested braking force BPRq as the instruction braking force BPTr, and controls the braking device 30 based on the instruction braking force BPTr.

When it is determined that the vehicle body speed VS is equal to or less than the second vehicle body speed determination value VSth2 and the vehicle 10 is not stopped, the processing circuit 51 executes the decrease correction process. That is, the processing circuit 51 decreases the instruction braking force BPTr until the instruction braking force BPTr is equal to the stop holding braking force BPth. The processing circuit 51 may set the decreasing speed of the instruction braking force BPTr at this time based on at least one of the vehicle body speed VS and the deceleration DVS acquired in step S17. For example, the processing circuit 51 sets the decreasing speed of the instruction braking force BPTr so that the smaller the vehicle body speed VS acquired in step S17, the larger the value. For example, the processing circuit 51 sets the decreasing speed of the instruction braking force BPTr so that the larger the deceleration DVS acquired in step S17, the larger the value. However, after the instruction braking force BPTr is equal to the stop holding braking force BPth, the processing circuit 51 holds the instruction braking force BPTr by the stop holding braking force BPth. Then, the processing circuit 51 controls the braking device 30 based on the set instruction braking force BPTr.

When it is determined that the vehicle 10 has Stopped, the processing circuit 51 executes the degeneration process. That is, the processing circuit 51 increases the instruction braking force BPTr to the requested braking force BPRq. Then, the processing circuit 51 controls the braking device 30 based on the set instruction braking force BPTr. Thereafter, the processing circuit 51 temporarily ends the series of processes.

### <Functions and Effects>

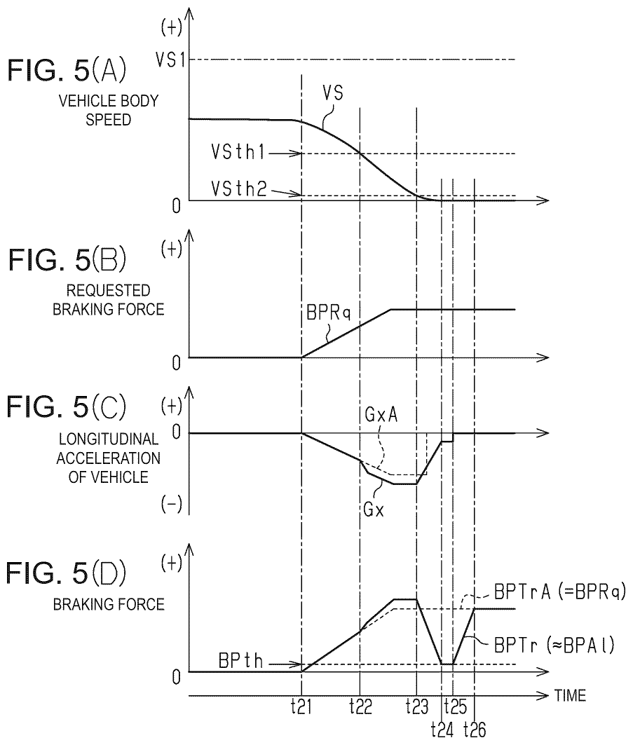

Functions and effects at the time of vehicle braking will be described with reference to FIGS. 5(A)-5(D). The solid line in FIG. 5(D) indicates the transition of the instruction braking force BPTr in the present embodiment, and broken line of FIG. 5(D) indicates the transition of the instruction braking force BPTrA in the comparative example. The solid line in FIG. 5(C) indicates the transition of the longitudinal acceleration Gx in the present embodiment, and the broken line FIG. 5(C) indicates the transition of the longitudinal acceleration GxA in the comparative example. In the comparative example, the stop-time braking control is not executed.

As illustrated in FIG. 5(A), the vehicle 10 is traveling in a state where the vehicle body speed VS is smaller than the first vehicle body speed VS1. Thus, the driver starts to operate the braking operation member 11 at timing t21 under the situation where the vehicle 10 is traveling at a low speed. Then, as illustrated in FIG. 5(B), the requested braking force BPRq is derived so that the larger the operation amount X of the braking operation member 11, the larger the value. The requested braking force BPRq is set as the instruction braking force BPTr. Then, the braking device 30 operates based on the instruction braking force BPTr.

In the present embodiment, when the braking request is generated in this way, the first vehicle body speed determination value VSth1 and the second vehicle body speed determination value VSth2 are set so that the smaller the vehicle body speed VS at that time, the smaller the value is. As a result, the first vehicle body speed determination value VSth1 and the second vehicle body speed determination value VSth2 are set so that the vehicle body speed is smaller than the vehicle body speed VS at timing t21.

In the example illustrated in FIGS. 5(A)-5 (D), since the vehicle body speed VS is the first vehicle body speed determination value VSth1 at timing t22 while the vehicle body speed VS decreases, the stop-time braking control is started. In a period from timing t22 to timing t23, the vehicle body speed VS is larger than the second vehicle body speed determination value VSth2. Therefore, the increase correction process of the stop-time braking control is executed. In this case, the instruction braking force BPTr is set so that the value is larger than the requested braking force BPRq, and the braking device 30 operates based on the instruction braking force BPTr.

Since the vehicle body speed VS is the second vehicle body speed determination value VSth2 at timing t23 during the execution of the increase correction process, the increase correction process ends and the decrease correction process starts. In the decrease correction process, the instruction braking force BPTr is reduced to the stop holding braking force BPth. Then, the braking device 30 operates based on the instruction braking force BPTr. The stop holding braking force BPth is smaller than the requested braking force BPRq. Therefore, the braking force BPAl is smaller than the requested braking force BPRq by executing the decrease correction process.

Since the instruction braking force BPTr is the stop holding braking force BPth at timing t24, the instruction braking force BPTr is held by the stop holding braking force BPth.

Then, since it is determined that the vehicle 10 has stopped at timing t25, the decrease correction process ends and the degeneration process starts. In the degeneration process, the instruction braking force BPTr is increased toward the requested braking force BPRq, and the braking device 30 operates based on the instruction braking force BPTr. When the instruction braking force BPTr reaches the requested braking force BPRq at timing t26, the stop-time braking control is terminated.

Here, the comparative example in which the stop-time braking control is not executed will be described. As indicated by the broken line in FIG. 5(D), in the comparative example, the requested braking force BPRq is continuously set as the instruction braking force BPTrA. Therefore, as indicated by the broken line in FIG. 5(C), the absolute value of the longitudinal acceleration Gx suddenly decreases at the timing when the vehicle 10 stops. In this case, the pitch attitude of the vehicle 10 suddenly changes due to a sudden change in the absolute value of the longitudinal acceleration Gx. Before the vehicle 10 stops, an inertial force due to deceleration of the vehicle 10 acts on an occupant of the vehicle 10. The inertia force at this time increases as the absolute value of the longitudinal acceleration Gx increases. Therefore, when the vehicle 10 stops, the inertial force is 0 (zero). That is, when the absolute value of the longitudinal acceleration Gx suddenly decreases due to the stop of the vehicle 10, the inertial force acting on the occupant also suddenly decreases. When the pitch attitude and the inertia force suddenly change due to the stop as described above, the occupant may feel uncomfortable.

In this regard, in the present embodiment, as illustrated in FIG. 5(C), the vehicle 10 can be stopped in a state where the absolute value of the longitudinal acceleration Gx is reduced as compared with the comparative example. As a result, a sudden change in the pitch attitude of the vehicle 10 due to the stop is suppressed. In addition, a sudden decrease in the inertial force due to the stop is suppressed.

Therefore, in the present embodiment, even when a braking request occurs in the vehicle 10 traveling at a low speed, it is possible to suppress a rapid change in the pitch attitude of the vehicle 10 upon stopping.

In the present embodiment, the following effects can be further obtained.
(1) The processing circuit 51 sets, as the first vehicle body speed determination value VSth1, a smaller value as the vehicle body speed VS at the time when the braking request is generated is smaller. As a result, even when the vehicle body speed VS at the time when the braking request is generated is small, the processing circuit 51 can execute the stop-time braking control. As a result, the braking control device 50 can stop the vehicle 10 in a State where the braking force BPAl is smaller than the requested braking force BPRq regardless of the magnitude of the vehicle body speed VS at the time when the braking request is generated.
(2) The processing circuit 51 sets the first vehicle body speed determination value VSth1 in consideration of the deceleration DVS of the vehicle 10. As a result, the processing circuit 51 can execute the stop-time braking control even when the operation speed of the braking operation member 11 by the driver is large. As a result, the braking control device 50 can stop the vehicle 10 in a state where the braking force BPAl is smaller than the requested braking force BPRq regardless of the deceleration DVS at the time of vehicle braking.

### <Modification>

The above embodiment can be modified as follows. The above embodiment and the following modification can be implemented in combination with each other within a range not technically contradictory.

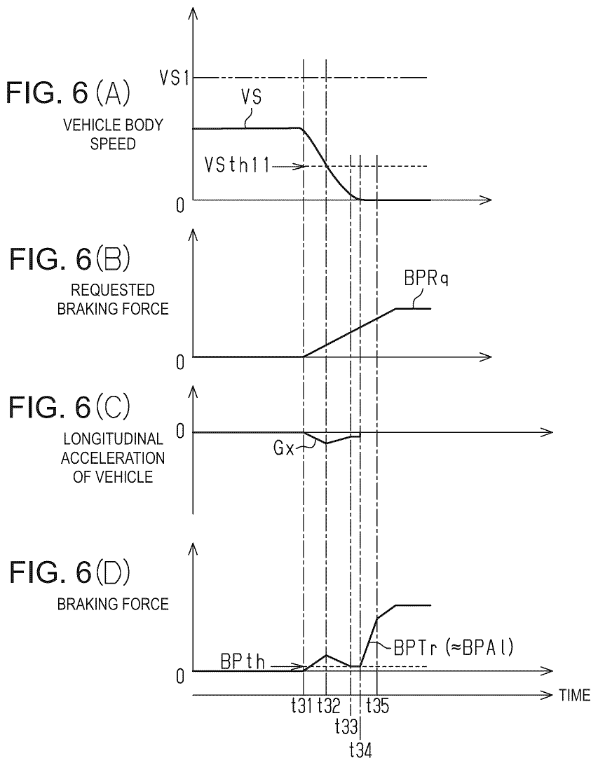

The stop-time braking control may not include the increase correction process as long as the stop-time braking control includes the decrease correction process and the degeneration process. FIGS. 6(A)-6(D) illustrate an example of a timing chart when the stop-time braking control not including the increase correction process is executed.

As illustrated in FIG. 6(A), the vehicle 10 is traveling in a state where the vehicle body speed VS is smaller than the first vehicle body speed VS1. Thus, the driver starts to operate the braking operation member 11 at timing t31 under the situation where the vehicle 10 is traveling at a low speed. Then, as illustrated in FIG. 6(B), the requested braking force BPRq is derived, and the requested braking force BPRq is set as the instruction braking force BPTr. Then, the braking device 30 operates based on the instruction braking force BPTr.

When the braking request is generated in this manner, a vehicle body speed determination value VSth11 is set so that the smaller the vehicle body speed VS at that time is, the smaller the value is. The vehicle body speed determination value VSth11 corresponds to the second vehicle body speed determination value VSth2 in the above embodiment. In this modification, the vehicle body speed determination value VSth11 corresponds to the “threshold value”. In the modification, the vehicle body speed determination value VSth11 is set so that the vehicle body speed is smaller than the vehicle body speed VS at timing t31.

Since the vehicle body speed VS is the vehicle body speed determination value VSth11 at timing t32, the decrease correction process of the stop-time braking control is started. In the decrease correction process, the instruction braking force BPTr is reduced to the stop holding braking force BPth, and the braking device 30 operates based on the instruction braking force BPTr. The stop holding braking force BPth is smaller than the requested braking force BPRq. Therefore, the braking force BPAl is smaller than the requested braking force BPRq.

Since the instruction braking force BPTr is the stop holding braking force BPth at timing t33, the instruction braking force BPTr is held by the stop holding braking force BPth.

Since it is determined that the vehicle 10 has stopped at the subsequent timing t34, the decrease correction process ends and the degeneration process starts. In the degeneration process, the instruction braking force BPTr is increased toward the requested braking force BPRq, and the braking device 30 operates based on the instruction braking force BPTr. When the instruction braking force BPTr reaches the requested braking force BPRq at timing t35, the stop-time braking control is terminated.

Even in the modification, the processing circuit 51 can execute the stop-time braking control even in a case where the braking request is generated while the vehicle 10 is traveling at a low speed. Therefore, even in the modification, even in a case where the braking request is generated in the vehicle 10 traveling at a low speed, it is possible to suppress the rapid change in the pitch attitude of the vehicle 10 upon stopping.
When the threshold value is set based on the vehicle body speed VS, the threshold value setting unit does not need to consider the deceleration DVS of the vehicle 10 when setting the threshold value.
The stop-related value acquisition unit may acquire other parameters other than the vehicle body speed VS as long as the parameters decrease in value as the vehicle 10 approaches the stop position PS. For example, the stop-related value acquisition unit may acquire, as the stop-related value, a stop distance, which is a distance from the current position of the vehicle 10 to the stop position PS. In this case, the threshold value setting unit sets, as the threshold value, a stop distance determination value, which is a determination value related to the stop distance. Specifically, the threshold value setting unit sets, as the stop distance determination value, a smaller value as the stop distance at the time point the braking request is generated is shorter. As a result, the braking control device can obtain functions and effects similar to those of the above embodiment.

Furthermore, for example, the stop-related value acquisition unit may acquire, as the stop-related value, a predicted stop time that is a time required for the vehicle 10 to stop. In this case, the threshold value setting unit sets, as the threshold value, a predicted stop time determination value that is a determination value related to a predicted stop time. Specifically, the threshold value setting unit sets, as the predicted stop time determination value, a smaller value as the predicted stop time at the time of occurrence of the braking request is shorter. As a result, the braking control device can obtain functions and effects similar to those of the above embodiment. An example of the predicted stop time is TTC. TTC is an abbreviation for “Time To Collision”.

The stop distance and the predicted stop time described above can also be said to be parameters whose values gradually decrease as the time passes in a case where the vehicle 10 is decelerated by application of the braking force.

The stop-related value acquisition unit may acquire, as the stop-related value, at least one of the vehicle body speed VS, the stop distance, and the predicted stop time. For example, the stop-related value acquisition unit may acquire the vehicle body speed VS and the stop distance as the stop-related value. In this case, the control unit preferably starts the stop-time braking control on condition that at least one of the condition that the vehicle body speed VS being equal to or less than the threshold value and the condition that the stop distance being equal to or less than the threshold value is satisfied.
The stop position setting unit may set the stop position PS by a method different from the method using the vehicle body speed VS or the deceleration DVS. For example, when the distance from the host vehicle to the preceding vehicle can be acquired, the stop position setting unit may set the stop position PS based on the distance. In this case, the stop position setting unit may set, as the stop position PS, a position closer to the host vehicle as the distance is shorter.
The braking control device may control not only the friction braking force but also the regenerative braking force at the time of executing the stop-time braking control. In this case, the total of the sum of the friction braking force applied to the vehicle 10 and the sum of the regenerative braking force applied to the vehicle 10 is the braking force BPAl.
In the above embodiment, the processing circuit 51 executes the stop-time braking control at the time of vehicle braking according to the operation of the braking operation member 11 by the driver. However, the processing circuit 51 may execute the stop-time braking control at the time of automatic braking.
The processing circuit 51 may be configured as a circuit including one or more processors that operate according to a computer program, one or more dedicated hardware circuits such as dedicated hardware that executes at least part of various processes, or a combination thereof. An example of the dedicated hardware can include an ASIC which is an application specific integrated circuit. The processor includes a CPU and a memory such as a RAM and a ROM, and the memory stores a program code or a command configured to cause the CPU to execute processing. The memory, that is, the storage medium, includes any available medium that can be accessed by a general-purpose or dedicated computer.

### <Other Technical Ideas>

Next, a technical idea that can be grasped from the above embodiment and modification will be described.
[Supplementary note 1] The stop-time braking control preferably includes
   an increase correction process of making the braking force to be applied to the vehicle larger than the braking force requested value, and
   a decrease correction process which is executed after the completion of the increase correction process and reduces the braking force applied to the vehicle to be smaller than the braking force requested value.
[Supplementary note 2] A braking control device includes
   a stop-related value acquisition unit that acquires a stop-related value whose value gradually decreases as time elapses when a vehicle is decelerated by application of a braking force,
   a control unit that starts stop-time braking control for stopping the vehicle in a state in which a braking force applied to the vehicle is smaller than a requested braking force that is a requested value of a braking force applied to the vehicle when the stop-related value is equal to or less than a threshold value, and
   a threshold value setting unit that sets the threshold value to a smaller value as the stop-related value is smaller before the stop-time braking control is started.

It is noted that the expression “at least one” as used herein means “one or more” of the desired options. As an example, the expression “at least one” as used herein means “only one option” or “both of two options” if the number of options is two. As another example, the expression “at least one” as used herein means “only one option” or “any combination of two or more options” if the number of options is three or more.

1. A braking control device comprising:
a stop-related value acquisition unit that acquires a stop-related value whose value decreases as a vehicle approaches a predetermined stop position;
a control unit that starts stop-time braking control for stopping the vehicle in a state in which a braking force applied to the vehicle is smaller than a requested braking force that is a requested value of a braking force applied to the vehicle when the stop-related value is equal to or less than a predetermined threshold value; and
a threshold value setting unit that sets the threshold value to a smaller value as the stop-related value is smaller before the stop-time braking control is started.

2. The braking control device according to claim 1, wherein
the threshold value setting unit sets the threshold value to a smaller value as the stop-related value at a time point when a braking request to the vehicle is generated is smaller.

3. The braking control device according to claim 2, wherein
the threshold value setting unit sets the threshold value based on deceleration of the vehicle.

4. The braking control device according to claim 1, wherein
the stop-related value acquisition unit acquires, as the stop-related value, at least one of a vehicle body speed of the vehicle and a stop distance that is a distance from a current position of the vehicle to the stop position.

5. The braking control device according to claim 1, wherein
the threshold value setting unit sets the threshold value based on deceleration of the vehicle.
